(19) United States
(12) Patent Application Publication
(10) Pub. No.: US 2026/0094781 A1
(43) Pub. Date: Apr. 2, 2026

(54) APPARATUS FOR APPLYING ACCELERATED ELECTRONS TO FLUIDS AND INNER WALLS OF HOLLOW BODIES

(71) Applicant: Fraunhofer-Gesellschaft zur Förderung der angewandten Forschung e.V., Munich (DE)

(72) Inventors: Gösta MATTAUSCH, Dresden (DE); Jörg KUBUSCH, Dresden (DE); Lars DINCKLAGE, Dresden (DE); Tobias TEICHMANN, Dresden (DE); Simone SCHOPF, Dresden (DE); André POREMBA, Dresden (DE); Ludwig LORENZ, Dresden (DE); Severin DOMINOK, Dresden (DE); Rainer LABITZKE, Dresden (DE); Kay MÖCKEL, Dresden (DE); Andre GRETSCHEL, Dresden (DE); Mirko KREUSEL, Dresden (DE); Burkhard ZIMMERMANN, Dresden (DE); Elizabeth VON HAUFF, Dresden (DE)

(73) Assignee: Fraunhofer-Gesellschaft zur Förderung der angewandten Forschung e.V., Munich (DE)

(21) Appl. No.: 19/335,504

(22) Filed: Sep. 22, 2025

(30) Foreign Application Priority Data
Oct. 1, 2024 (DE) 10 2024 128 457.9

(51) Int. Cl. H01J 33/04; H01J 15/00

(52) U.S. Cl. CPC H01J 33/04; H01J 15/00

(57) ABSTRACT

An apparatus is provided for impinging fluids and inner walls of hollow bodies with accelerated electrons, comprising a cylindrical electron exit window as a component of a cylindrical housing having a cylinder axis and enclosing an evacuable space; a wire-shaped, strand-shaped, rod-shaped, annular, helical, or cylindrical cathode which is arranged within the evacuable space and is enclosed by the cylindrical electron exit window and by a cylindrical control grid, wherein the cylindrical control grid has a diameter that is smaller than the diameter of the cylindrical electron exit window and a first power supply unit is connected between the wire-shaped, strand-shaped, rod-shaped, annular, helical, or cylindrical cathode and the cylindrical electron exit window, so that electrons can be emitted from the wire-shaped, strand-shaped, rod-shaped, annular, helical, or cylindrical cathode and accelerated radially away from the cylinder axis of the cylindrical housing in the direction of the cylindrical electron exit window.

### CROSS-REFERENCE TO RELATED APPLICATIONS

This application claims priority under 35 USC § 119 to German Patent Application No. 10 2024 128 457.9, filed Oct. 1, 2024, which is hereby incorporated by reference.

### TECHNICAL FIELD

The invention relates to an apparatus for generating accelerated electrons with which fluids and inner walls of hollow bodies can be preferably impinged.

### BRIEF DESCRIPTION OF THE DRAWINGS

The embodiments may be better understood with reference to the following drawings and description. The components in the figures are not necessarily to scale.

FIG. 1 is a schematic representation of a horizontal section of an apparatus according to the invention;

FIG. 2 is a schematic representation of a vertical section of the apparatus according to the invention shown in FIG. 1;

FIG. 3 is a schematic representation of a horizontal section of a first alternative apparatus according to the invention;

FIG. 4 is a schematic representation of a vertical section of the first alternative apparatus according to the invention shown in FIG. 3;

FIG. 5 is a schematic representation of a horizontal section of a second alternative apparatus according to the invention;

FIG. 6 is a schematic representation of a vertical section of the second alternative apparatus according to the invention shown in FIG. 5;

FIG. 7 is a schematic representation of a horizontal section of a third alternative apparatus according to the invention;

FIG. 8 is a schematic representation of a vertical section of the third alternative apparatus according to the invention shown in FIG. 7; and

FIG. 9 shows a component 900 of an apparatus according to the invention.

### DETAILED DESCRIPTION

Electron beam technology has been used on an industrial scale for several decades for chemical modification, as well as disinfection and sterilization of a wide variety of materials and products. This treatment can be carried out economically at atmospheric pressure if the electrons are first released in a vacuum, then accelerated and finally coupled out into the treatment zone through a beam exit window, usually a thin metal foil. In order to penetrate adequately robust electron exit windows suitable for large-scale use and to ensure sufficient treatment depth in the product, acceleration voltages of >80 kV are typically required.

Various methods and beam sources for surface treatment of flat products, such as plates and strips, are well established, whereas the treatment of shaped bodies, bulk materials, inner walls of hollow bodies, and fluids on all sides still poses problems. Thus, uniformly impinging curved surfaces on all sides with electrons is geometrically problematic due to obscuration effects, variable absorption of electron energy along the gas path, and dose inhomogeneities due to different projection ratios.

With already existing source systems, such as axial emitters with a fast deflection unit or ribbon emitters (DE 196 38 925 C2) with an elongated cathode, both of which are usually operated with a heated thermionic cathode, achieving product treatment on all sides is cumbersome, requires additional installations, or involves high levels of expenditure in terms of equipment and/or technology and/or time.

For example, DE 10 2006 012 666 A1 describes a solution which comprises three axial emitters with associated deflection control and three associated electron exit windows. The three electron exit windows are arranged in such a way that they completely enclose a triangular free space. Upon being guided through this free space, the cross section of a substrate can be comprehensively impinged with accelerated electrons in one treatment pass. However, if the substrate does not have the same triangular cross section as the free space enclosed by the three electron exit windows, the dose distribution of the accelerated electrons on the surface of the substrate will be inhomogeneous. The outlay for the equipment required for this design is also very high, which makes this solution very expensive.

An apparatus is known from DE 4434 767 C1 in which a bulk material flow passes between two surface beam generators and can be impinged with accelerated electrons from both sides. EP 0513 135 B1 describes such two-sided impingement of the freely falling bulk material flow using two mirror-inverted axial beam sources with a scanner. What both solutions have in common is the need to use two electron beam sources along with all of their supply and control components, which still involves a high level of outlay for equipment.

DE 199 42 142 A1 discloses an apparatus in which bulk material is guided past a single-surface beam generator in multiple free fall cycles and impinged with accelerated electrons. Due to the multiple passes, combined with the interim mixing of the bulk material and the application of only a fraction of the total required target dose per pass, the probability of the particles of the bulk material being uniformly impinged with accelerated electrons on all sides is statistically higher in this design. However, the plurality of passes requires a lot of time to carry out the treatment process.

An annular apparatus for generating accelerated electrons is disclosed in DE 10 2013 111 650 B3, in which all essential components, such as the cathode, anode, and electron exit window, are annular, where such an apparatus enables an annular electron beam to be formed, and in which the accelerated electrons move toward the interior of the ring. Using just one such annular source, bulk materials (DE 10 2013 113 688 B3) and gaseous media (DE 10 2019 134 558 B3), for example, can be fully impinged with accelerated electrons from the outside. This likewise applies to strand-shaped substrates or medical packaging moved through the annular opening of the apparatus, where the controllability of the dose transfer along the circumference (DE 10 2017 104 509 A1), as well as apparatuses for stabilization and online control of the processes (DE 10 2022 114 434 A1) are of particular importance. The disadvantage, however, is that such annular sources are voluminous due to the external cold cathodes, insulators, and vacuum vessels, and electron treatment of substrates can only be carried out in the relatively small volume of the annular interior and on external product surfaces.

DE 10 2018 111 782 A1 describes apparatuses with cold cathodes which can also generate a ring of accelerated electrons, where the movement of the electrons is directed radially outward. With this arrangement, which is inverted with respect to the direction of electron propagation compared to DE 10 2013 111 650 B3, a more favorable ratio between the size of the electron source and the volume of the treatment zone is achieved.

The disadvantage remains that the cold cathodes described in DE 10 2018 111 782 A1 emit electrons only as a result of stimulation by high-energy ions, which must be provided by an integrated plasma source, which always involves enhanced effort and expense and increased installation space, especially at the very low pressures required in order for a plasma source to maintain the insulating capacity of the vacuum against gas breakthroughs at the technologically required acceleration voltage.

Moreover, this annular source also suffers from the same weakness that all treatment arrangements equipped with only one electron source do, namely the tendency for the energy dose to be deposited unevenly on the various surface areas of the material to be treated (facing toward or facing away from the electron exit window). This is then to be ameliorated by (time-consuming) multiple passes or the provision of electron reflectors on the rear side of the material to be treated facing away from the electron exit window, as described above (the dose contribution of which is, however, several times lower than that applied by the primary beam electrons on the front side). Both methods can only alleviate the problem of insufficient dose homogeneity but cannot satisfactorily solve it.

An additional requirement for vertical extension of the opening area of an electron exit window is posed by treatment technologies with high dose requirements, such as sterilization tasks and the degradation of pollutants in fluids. This results from the fact that the electrons accelerated inside the beam source transfer part of their energy to the metal foil and the support grid as they pass through the electron exit window causing them to heat up. Electron exit windows are therefore generally cooled, but in order to avoid their thermal damage, the current density of the electrons must still be limited. Likewise, when the acceleration voltage is defined by the technology, this corresponds to a limited surface dose rate of the electron beam source. An increase in the dose transferred to the material to be treated can therefore only be achieved through a longer electron exposure time, i.e., either by reducing the substrate speed, which is undesirable for productivity reasons, or by extending the opening area of the electron exit window in the transport direction of the substrates, for example, in the vertical fall direction of bulk material particles.

The latter, however, cannot be achieved with the apparatus described in DE 10 2018 111 782 A1, because it conflicts with the horizontal arrangement of cooling channels above and below the opening area of the electron exit window, which is implicitly indicated in the cross-sectional drawings. It is known that the distance between these cold surfaces to which the absorbed portion of the electron energy must be dissipated by heat conduction through the support grid must not be chosen too large (being limited to only about 7 to 10 cm in practically designed setups), since the temperature increase of metal foil and support grid increases linearly with the heat flux density and quadratically with respect to the distance to the heat sink (i.e., the actively cooled edge of the opening area). The resulting limitation of the vertical extent of the uninterrupted opening area not only limits the uniformity that can be achieved, but also the dose that can be achieved on the material to be treated in a single pass.

Particularly when treating fluids that contain solid particles (such as exhaust gases), protecting the metal foils from the solid particles themselves is of great importance. Larger particles can cause direct mechanical damage to the foil; the accumulation of dust would impair the transmission of electrons (and thus reduce the dose transferred to the product) and increase the locally absorbed portion of the electron energy (thus causing localized thermal damage to the metal foil and thus promoting vacuum leaks). It is therefore obvious that process-related components are critical for protecting the electron exit window, however, DE 10 2018 111 782 A1 does not contain any technical teaching in this regard.

The invention is therefore based on the technical problem of providing an apparatus for generating accelerated electrons whereby the disadvantages of the prior art can be removed. In particular, an apparatus with a compact design is to be provided with which both fluids and the inner walls of hollow bodies can be impinged with accelerated electrons, thereby achieving high dose values in the treatment medium and a long continuous operating time.

An apparatus according to the invention for impinging fluids and inner walls of hollow bodies with accelerated electrons comprises a cylindrical electron exit window as a component of a cylindrical housing having a cylindrical axis which encloses an evacuable space; at least one wire-shaped, strand-shaped, rod-shaped, annular, helical, or cylindrical cathode which is arranged within the evacuable space and enclosed by the cylindrical electron exit window and by a cylindrical control grid. The cylindrical control grid has a diameter that is smaller than the diameter of the cylindrical electron exit window. Furthermore, a first power supply unit is connected in an electrically conductive manner between the wire-shaped, strand-shaped, rod-shaped, annular, helical, or cylindrical cathode and the cylindrical electron exit window, so that electrons can be emitted from the wire-shaped, strand-shaped, rod-shaped, annular, helical, or cylindrical cathode and accelerated radially away from the cylinder axis of the cylindrical housing in the direction of the cylindrical electron exit window.

After the accelerated electrons have passed through the cylindrical electron exit window, a medium outside the cylindrical electron exit window and in a ring around the cylindrical electron exit window can be impinged with the accelerated electrons. An apparatus according to the invention further comprises a first hollow cylinder which encloses the cylindrical electron exit window, the first hollow cylinder and the cylindrical electron exit window being spaced apart from one another. Thus, a first annular free space is formed between the first hollow cylinder and the cylindrical electron exit window through which a fluid to be impinged with accelerated electrons flows, streams, or trickles. Such a fluid may contain liquid, vaporous, and/or gaseous components.

Alternatively, the inner wall of a pipe or hose to be impinged with accelerated electrons, or at least partially and approximately that of an arbitrarily shaped hollow body as well, can also be associated with the first hollow cylinder. The area throughput required for a large-area, uniform dose application can be achieved by a relative movement, in which case either the pipe (or hose or hollow body of any shape) or the beam source or both move(s).

Both a cylindrical electron exit window and a cylindrical control grid usually comprise support elements which provide the cylindrical electron exit window and the cylindrical control grid with the required mechanical stability. One disadvantage of such support elements, however, is that they negatively impact the flight motion of accelerated electrons which strike support elements or, in the worst case, completely absorb the energy of these electrons. This energy, previously applied by the high-voltage supply, is thus withdrawn from the treatment process, which compromises energy efficiency and causes thermal stress on the electron source. In an apparatus according to the invention, therefore, as a further essential feature, first support elements of the cylindrical control grid and second support elements of the concentrically arranged, cylindrical electron exit window are arranged so as to be aligned point-symmetrically along the respective lateral surfaces and azimuthally within equal angular segments with an angle ω. In a preferred embodiment, the first support elements of the cylindrical control grid and the second support elements of the cylindrical electron exit window run parallel to the cylinder axis and are arranged according to the invention within the same first angular segments with an angle ω.

Moreover, such first angular segments with the angle ω are referred to below as obscuration angle segments or obscuration angular regions. An apparatus according to the invention comprises several of these obscuration angle segments, which, in a preferred embodiment, are spaced apart from one another by the same angular dimension. In an apparatus according to the invention, second angular segments are thus formed between the obscuration angle segments in which the accelerated electrons are not hindered by support elements of the cylindrical electron exit window and the cylindrical control grid running parallel to the cylinder axis, which results in a higher electron dose in these angular segments with which a fluid or an inner wall of a hollow body can be impinged compared to the prior art.

In an apparatus according to the invention, electrons are emitted from the wire-shaped, strand-shaped, rod-shaped, annular, helical, or cylindrical cathode, which is arranged centrally and extends along the cylinder axis of the cylindrical housing. The cathode can be embodied as, e.g., a hot cathode or as a plasma cathode. In the case of a plasma cathode, it is preferably rod-shaped or cylindrical. In a preferred embodiment, the wire-shaped, strand-shaped, rod-shaped, annular, helical, or cylindrical cathode is traversed by an electric current, is thereby heated, and is thus embodied as a thermal emitter—i.e., as a hot cathode. For this purpose, the wire-shaped, strand-shaped, rod-shaped, annular, helical, or cylindrical cathode is electrically connected to the negative pole of a first power supply unit. The positive pole of the first power supply is electrically connected to the cylindrical electron exit window, so that it has an electrically positive potential compared to the control grid and cathode.

In a simple embodiment, the electron exit window has the electrical ground potential. However, more complex technological tasks, which will be described below, can benefit from constructing the electron exit window such that it is electrically isolated from ground and from adjusting or varying its electrical potential in a defined manner using an intermediate (DC, AC, or pulsed) voltage source.

Due to the positive potential applied to the cylindrical electron exit window in relation to the cathode, the electrons emitted by the wire-shaped, strand-shaped, rod-shaped, annular, helical, or cylindrical cathode are accelerated radially outward toward the cylindrical electron exit window. After passing through the cylindrical control grid and exiting the cylindrical electron exit window, the accelerated electrons pass through the first annular free space and strike the inner wall of the first hollow cylinder.

If a fluid within the first annular free space is to be impinged with accelerated electrons, it is advantageous if at least the inside of the first hollow cylinder, at least in the area opposite the electron exit window, is composed of a material that reflects electrons well. That way, those electrons which reach the inside of the first hollow cylinder can be reflected by the first hollow cylinder and again contribute to the impingement of the fluid with accelerated electrons. The aforementioned area of the first hollow cylinder can be composed entirely of a material that reflects the electrons, or the first hollow cylinder can also be coated with an electron-reflecting material only on the inside in the previously mentioned area. One example of a suitable material for reflecting electrons is a temperature-resistant metal with a high atomic number, such as tungsten or a tungsten alloy. It is advantageous if at least the electron-reflecting region of the first hollow cylinder is cooled so that it does not heat up the air in the treatment zone of the first annular free space. Such cooling can be implemented as water cooling, for example.

In another embodiment of the invention, the cylinder axis of the cylindrical housing is aligned perpendicular to the Earth's surface, so that, for example, a liquid film which is to be impinged with accelerated electrons can run down the inner wall of the first hollow cylinder. Since it is not always possible, particularly in the case of a mobile system, to align a system in such a way that the cylinder axis is completely vertical, the alignment of the cylinder axis of the cylindrical housing can also deviate from a perpendicular to the Earth's surface by an angle of approximately 100 or less.

The invention is described in more detail below with reference to the exemplary embodiments.

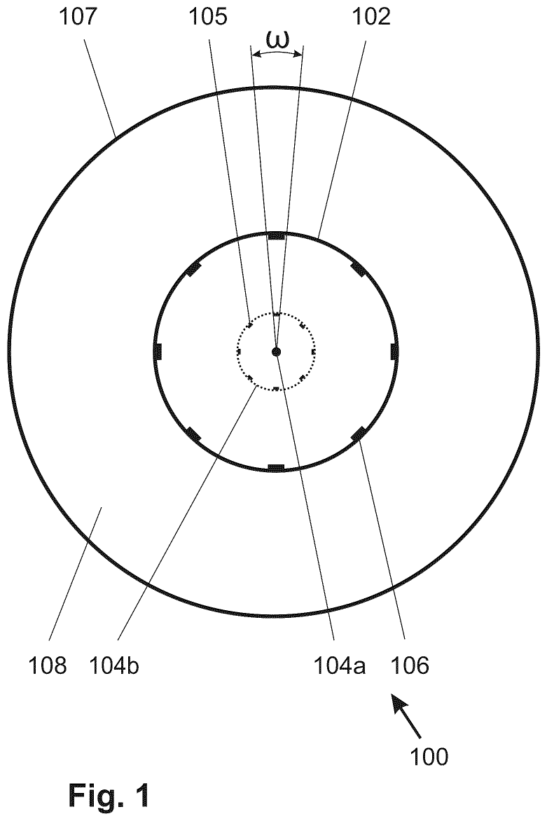

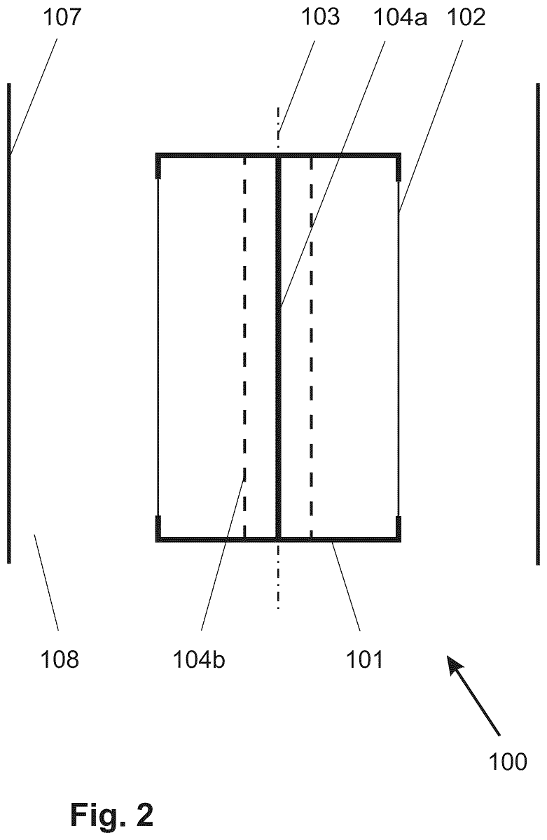

In FIGS. 1 and 2, one and the same apparatus 100 according to the invention is shown schematically, with FIG. 1 showing a horizontal section and FIG. 2 showing a vertical section. The apparatus 100 comprises a cylindrical housing 101 which encloses an evacuable space. A vacuum can be maintained within the evacuable space by means of at least one vacuum pump, which is not shown in the figures for reasons of clarity, but is known from the prior art. A wall region of the housing 101 is embodied as a cylindrical electron exit window 102. The cylindrical housing 101 has a circular cross section and a cylinder axis 103 which is oriented perpendicular to the Earth's surface and encloses a centrally arranged cathode 104a.

It should be noted that, in this exemplary embodiment and in the exemplary embodiments described below, the cylinder axis 103 is aligned perpendicular to the Earth's surface only by way of example. In an apparatus according to the invention, the cylinder axis 103 can alternatively have any other angle relative to the Earth's surface. In a preferred embodiment, however, the cylinder axis (103) of the cylindrical electron exit window (102) is oriented perpendicular to the Earth's surface or deviates from the vertical by an angle of approximately 10° or less.

The cathode 104a is rod-shaped, extends along the cylinder axis 103, and consists of a wire through which an electric current flows. In one embodiment, the hot cathode comprises a ceramic rod around which a wire is helically wound. The material of the cathode 104a may, for example, comprise at least one of the chemical elements tungsten or tantalum. The cathode 104a is heated as a result of the flow of current, which in turn causes thermal emission of electrons. The cathode 104a is thus embodied as a hot cathode. The electrons emitted by the cathode 104a are accelerated radially outward toward the cylindrical electron exit window 102 because the cylindrical electron exit window 102 has an electrical anode potential. For this purpose, the cylindrical electron exit window 102 is electrically connected to the positive pole of a first power supply unit and the cathode 104 is connected to the negative pole of the first power supply unit. For reasons of clarity, the first power supply unit is not shown in the figures. The apparatus 100 is thus embodied as a cylindrical electron beam generator which generates a ring of accelerated electrons whose movements are directed radially outward.

However, forming the cathode of an apparatus according to the invention as a thin wire, as is done in cathode 104a, also entails additional requirements. The high operating temperature of the wire required for thermal emission of electrons causes recrystallization of the wire material and to changes in the length of the wire. If it is made of metal, an increase in temperature generally results in an extension of the wire. However, the extension of a vertically firmly secured wire causes compression and bending thereof, so that it no longer runs exactly along the cylinder axis 103, which can adversely affect the homogeneity of the circumferential electron emission and, ultimately, the dose distribution on the material to be treated. The embrittlement of a metal wire, which is also associated with recrystallization, can even cause breakage as a result of this compression, especially under alternating thermal stress. As an alternative to a metal wire, carbon fibers can therefore also be used as a hot cathode, in which case the hot cathode is strand shaped. However, such carbon fibers contract when the temperature increases. If clamped tightly, high tensile stresses will develop, which would cause the cracking of such a hot cathode.

Therefore, in an apparatus according to the invention, it is expedient for a wire-shaped, strand-shaped, rod-shaped, annular, helical, or cylindrical hot cathode to be securely clamped, e.g., only at the upper end, being guided radially, but mounted in an axially displaceable manner at the bottom. When the apparatus is operated vertically, the upper end corresponds to the end further away from the direction of action of the Earth's gravity vector. It is advantageous to make contact with the hot cathode at the lower end using a clamping piece which, by dint of its weight, always maintains a moderate tensile stress that is sufficient to tighten the cathode wire but prevents it from flowing or cracking. Alternatively, the hot cathode can be securely clamped or supported only at the lower end and contacted at the upper end with an axially movable clamping piece. When the apparatus is operated vertically, the lower end corresponds to the end closest to the direction of action of the Earth's gravity vector.

If a hot cathode is heated directly by a current flow, an electrical potential gradient is created in the longitudinal direction. This causes a change in the electric field strength and thus in the electron emission in the longitudinal direction of the hot cathode. In order to achieve a more uniform distribution of electron emission along the longitudinal extension of the hot cathode, the potential gradient must be minimized. To bring this about this, a hot cathode can also be heated indirectly (for example by means of thermal conduction, thermal radiation, or electron impact).

For this purpose, in one expedient embodiment, a rod-, strand- or wire-shaped heating element is arranged inside a cylindrical hot cathode, centrally along the cylinder axis of the cylindrical hot cathode and so as to be electrically insulated from the cylinder wall, and this heating element is heated by means of a current flow. The heating element must be operated at high temperature in order to heat the hot cathode to emission temperature, and is therefore made of a material with a high melting temperature (greater than 1500 K). Refractory metals (such as tungsten, tantalum, or molybdenum) or carbon fibers are suitable for this purpose.

In a first variant of this embodiment, a high-temperature-resistant, electrically low-conductive material (such as boron nitride or zirconium oxide) is introduced between the central heating element and the cylindrical hot cathode, and the heat of the central heating element is transferred to the cylindrical hot cathode by thermal conduction.

In a second variant of the above-mentioned embodiment, the heating element and the hot cathode are mounted contactlessly and the heat of the central heating element is transferred to the cylindrical hot cathode by way of thermal radiation. A particularly advantageous embodiment of this variant is achieved if the central heating element and the cylindrical hot cathode are each connected in an electrically conductive manner to one another at one end and the current is returned through the heating element via the cylinder wall of the cylindrical hot cathode. This result is a compensation for the magnetic field associated with the heating current, which adversely affects electron propagation (i.e., its extinction in the external environment of the hot cathode). The cylindrical wall of the hot cathode is designed to be sufficiently thick so as to have a low electrical resistance, whereby the potential gradient arising in the longitudinal direction is kept as low as desired. This results in a more homogeneous extraction field around the emission surface of the cylindrical hot cathode and thus in a more uniform electron emission distribution along the longitudinal axis of the hot cathode.

In a third variant of the above-mentioned embodiment, the heating element and the hot cathode are also mounted contactlessly and completely electrically insulated from one another. The hot cathode can then be connected to the positive terminal and the heating element to the negative terminal of an additional power supply. If the heating element is heated to emission temperature, the electrons emitted by it are drawn to the inner wall of the hot cathode, and heat it through electron impact.

In all three variants described, it is advisable that the cylindrical hot cathode be made of a material with a high melting point (greater than 1500 K) and a moderate to low work function (less than 5 eV). Suitable materials for this purpose include refractory metals (tungsten, tantalum, molybdenum, niobium), titanium, zirconium or stainless steel, all of which can be coated with compounds (such as oxides) in order to reduce the electron work function, as well as ceramics with a high melting temperature (such as rare earth borides, with lanthanum hexaboride being the most well-known representative).

Indirect heating of a cylindrical hot cathode also produces a change in its length. With such a geometry, it is advisable to clamp or support the hot cathode at the lower end and to enable stress-free length compensation by means of axially movable, radially guided upper clamping and contacting.

Furthermore, it is expedient for all embodiments of a hot cathode to provide radial adjustability of the upper and lower clamping and contacting points in order to bring about optimal alignment of the hot cathode along the vertically aligned cylinder axis 103 and thus a uniform field strength and a resulting uniform electron emission along the entire cathode circumference.

Moreover, in an apparatus according to the invention, such as the apparatus 100, the cathode 104a is enclosed by a cylindrical control grid 104b, which has a diameter that is smaller than the diameter of the cylindrical electron exit window 102. The grid structure of the cylindrical control grid 104b is fully formed. The cylindrical control grid 104b is composed of an electrically conductive material, is electron-transparent, and has an electrical voltage potential that is slightly more positive than the electrical voltage potential of the cathode 104a. In one embodiment, the cylindrical control grid 104b has a differential voltage from the cathode 104a of approximately +20 V to approximately +2000 V. The voltage potential for the cylindrical control grid can be provided by means of a separate second power supply unit or, alternatively, by means of a separately controllable second channel of the first power supply unit. As an electron-transparent gauze cylinder, the cylindrical control grid 104b reduces the electric field strength inside the gauze cylinder, enables the installation of optional holders for the cathode wire along the longitudinal extension, and ensures uniform, electron extraction on all sides, which is tolerant within certain limits even against positional deviations of the cathode wire, regardless of the accelerating voltage acting in the external space. Furthermore, the adjustability of the differential voltage between the control grid and the cathode, in addition to the variation of the heating current flowing through the cathode wire, offers a second, very dynamic possibility for controlling the emitted electron current. A similar cylindrical control grid in combination with a cathode wire is already known from prior-art ribbon emitters. In the case of base elements for clamping the cathode wire and the cylindrical control grid 104b in an apparatus according to the invention, it is therefore also possible to resort to constructive solutions which are known from prior-art ribbon emitters, e.g., from DE 196 38 925 C2.

In order to provide mechanical stability to the cylindrical control grid 104b and the cylindrical electron exit window 102, both components have support structures. Such support structures may include support elements that extend parallel to the cylinder axis 103 and also support elements that run annularly around the cylinder axis. A disadvantage of such support structures, which are also known from the prior art, is that accelerated electrons striking a support structure dissipate at least some of their energy into the support structure, which is then no longer available for the impingement of a fluid. According to the invention, first support elements 105 of the cylindrical control grid 104b extending parallel to the cylinder axis 103 of the cylindrical housing 101 and second support elements 106 of the electron exit window 102 extending parallel to the cylinder axis 103 are therefore arranged within the same first angular segments with an angle ω. Adjacent first angular segments are spaced apart from one another by the same angular dimension. If an apparatus according to the invention also has apparatuses for cooling the control grid 104b and/or for cooling the electron exit window 102, then cooling elements extend parallel to the cylinder axis 103 are preferably arranged within the first angular segments. The same also applies to signal or control lines that extend through or within the cylindrical housing parallel to the cylinder axis 103.

Although an apparatus according to the invention, such as the apparatus 100, thus has first angular segments (so-called obscuration angle regions) within which no medium can be impinged with accelerated electrons, such an apparatus also has second angular segments between the first angular segments within which no support elements of the control grid 104b and of the electron exit window 102 extending parallel to the cylinder axis 103 adversely affect the trajectory of accelerated electrons and within which, a medium can therefore be impinged with a high density of accelerated electrons.

The apparatus 100 according to the invention further comprises a first hollow cylinder 107 which encloses the cylindrical electron exit window 102, where the first hollow cylinder 107 and the electron exit window 102 are spaced apart from one another. The cylinder axis of the hollow cylinder 107 and the cylinder axis of the cylindrical electron exit window are identical and correspond to the cylinder axis 103 of the cylindrical housing 101, so that a first annular free space 108 is formed between the hollow cylinder 107 and the cylindrical electron exit window 102.

As already explained above, the cylindrical electron exit window 102 has a positive electrical potential relative to the control grid and cathode, so that the electrons emitted by the current-carrying cathode 104a are initially accelerated in the direction of the cylindrical electron exit window 102. After exiting the cylindrical electron exit window 102, the accelerated electrons pass through the first annular free space 108 and thereby impinge upon a liquid, gaseous, or vaporous fluid which is moved through the first annular free space 108. A liquid, gaseous, or vaporous fluid is referred to hereinafter as the material to be treated. Furthermore, the area of the first annular free space 108 within which a material to be treated can be impinged with accelerated electrons is also hereinafter referred to as the treatment zone.

In order to improve the homogeneity of the dose of accelerated electrons introduced into a material to be treated, the radial distance between the cylindrical electron exit window 102 and the first hollow cylinder 107 is set smaller than the electron range in the material that is to be penetrated, so that only a section of the entire depth dose distribution with thus defined limited variability acts on the area filled with material to be treated.

Depending on the temperature regime required by the technology within the treatment zone, the first hollow cylinder 107 can be either water-cooled or thermally insulated. In the latter case, the energy of the electrons thereby absorbed or the thermal contact with the material being treated results in its heating until it reaches temperature equilibrium with its surroundings due to heat radiation.

In addition, in order to further optimize the radial dose compensation, it is expedient to design the first hollow cylinder 107 as a so-called electron reflector, which at least partially scatters the electrons not absorbed by the material to be treated into the treatment chamber and onto the outside of the material to be treated (facing away from the electron exit window 102). An electron reflector usually consists of a temperature-resistant metal with a high atomic number, preferably tungsten, which has a particularly high backscatter coefficient, or of a more economical construction material, which is provided on the inner wall of the first hollow cylinder 107 with a layer of the aforementioned (“refractory”) metals or a compound such as tungsten carbide, the thickness of which is dimensioned such that a complete deceleration of the incident and non-reflected electrons can take place therein.

If, on the other hand, the minimization of parasitic X-ray radiation is pursued as a further optimization goal in an apparatus according to the invention, it is more expedient to design the first hollow cylinder 107 as a so-called electron absorber, i.e., to construct it from a temperature-resistant material with a low atomic number, such as carbon or light metal carbides, which (at the cost of a likewise low backscatter coefficient for electrons) release only a few and also, low-energy X-ray photons when the electrons are decelerated.

In an apparatus according to the invention, such as the apparatus 100, the electrons absorbed by the first hollow cylinder 107 must be discharged in a defined manner in order to avoid electrical charging of the first hollow cylinder 107. In the simplest case, it is sufficient to make the first hollow cylinder 107 electrically conductive and connect it to the ground potential.

However, more complex technological tasks, which will be described below, may benefit from constructing the first hollow cylinder such that it is electrically insulated from ground, and adjusting or varying its electrical potential in a defined manner using an interposed (DC, AC, or pulsed) voltage source.

In another embodiment, the first hollow cylinder is advantageously used in the sense of an inline quality monitoring system for the spatially and temporally resolved measurement of the electron current density that is incident from the electron exit window 102. For this purpose, a number of sensors (for example, embodied as metal sheets) are arranged on the inner wall of the first hollow cylinder 107 and distributed over the circumference and height thereof, electrically insulated from the electrical ground and from each other, which sensors act as electron collectors and make the locally absorbed electron current individually accessible to an evaluation unit. The spatial resolution, but also the metrological effort increases with the number of sensors. Therefore, the achievable precision of such an inline quality monitoring system and the associated effort must be weighed against each other depending on the application. If such a measuring device is used to first record values without the material to be treated and then with the material to be treated, an evaluation thereof allows inferences to be made about the vertical and azimuthal uniformity of the output current density emitted by the electron source, the temporal constancy thereof, and the resulting dose homogeneity on the material to be treated in the subsequent process. In technological operation, i.e., with material to be treated, the change in the leakage current distribution measured on the inner wall of the first hollow cylinder 107 compared to the initial current density determined without material to be treated is a measure of the amount of energy absorbed by the material to be treated, again with spatial and temporal resolution. A change in the absolute value due to a specification of the beam parameters changed manually by an operator or automatically by a control program can be taken into account and recalculated in the evaluation unit.

In one embodiment, the wall of the first hollow cylinder 107 is completely closed. With such a first hollow cylinder 107 and the previously described features of the apparatus 100, fluid treatment can be realized in the simplest case by having the fluid flow (or be sprayed) past the electron exit window over the entire cross section of the treatment zone in the direction of the extension of the cylinder axis, in which case the fluid is also in direct contact with the cylindrical electron exit window 102 and can additionally cool the latter. In an alternative approach, and when a fluid to be treated with accelerated electrons is in the form of a liquid, it can flow down under the effects of adhesion and gravity as a thin, uniform liquid film on the outer wall of the cylindrical electron exit window 102, on the inner wall of the first hollow cylinder 107, or on both simultaneously, in which case a cooling gas must flow through the then remaining free cross section of the annular free space 108. An inert cooling gas merely prevents overheating of the electron exit window 102 and/or the fluid; a reactive cooling gas can simultaneously contribute to the chemical modification of the fluid.

For reasons of energy efficiency, and in order to reduce the thermal load on the electron source, it is advantageous not to allow any electrons to strike the electron exit window 102 or the horizontal boundaries thereof and vertical support and cooling structures outside the frontal upper and lower boundaries of the opening areas of the electron exit window 102, but in particular within the obscuration angular regions, since these would be absorbed and thus contribute to the parasitic heating of the electron beam generator, but not to its technological dose rate. For this purpose, the cylindrical control grid 104b and/or the electron exit window 102 can be designed such that they are not completely transparent to electrons but rather are provided with defined opening areas that are aligned with the angular areas of the electron exit window 102 that are not covered by obscuration angular regions with the angle ω. Electrons emitted by the thermionic cathode and striking the control grid 104b in the closed obscuration angular region are absorbed there and do not reach the electron exit window 102. Since they only pass through a small potential difference and thus have absorbed little energy, this beam-forming absorption at the control grid does not constitute a serious loss factor.

In another alternative embodiment, the first hollow cylinder 107 is embodied as a component of a hollow body whose inner wall is to be impinged with accelerated electrons. Because of the previously described shielding angle segments, it is expedient if, in such an application, the first hollow cylinder 107 and/or the cylindrical housing 101 perform a rotational movement about the cylinder axis 103 in order to impinge the entire inner wall of the hollow cylinder 107 with accelerated electrons.

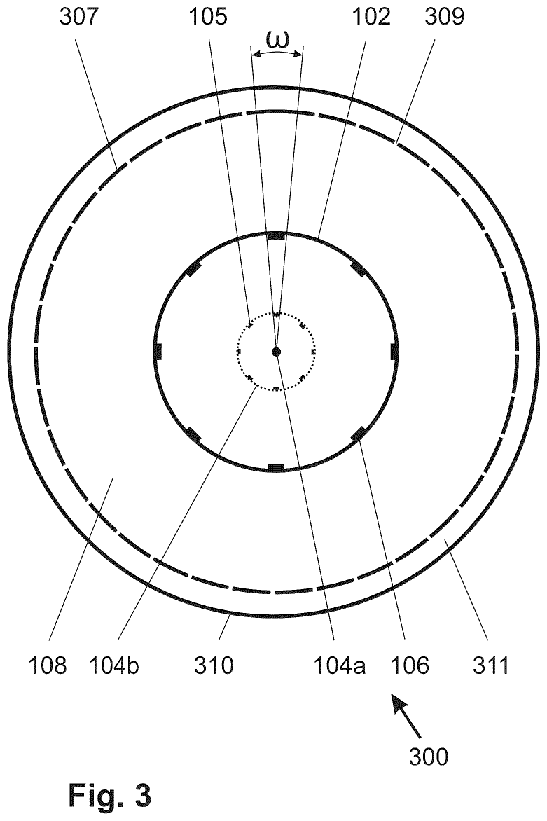

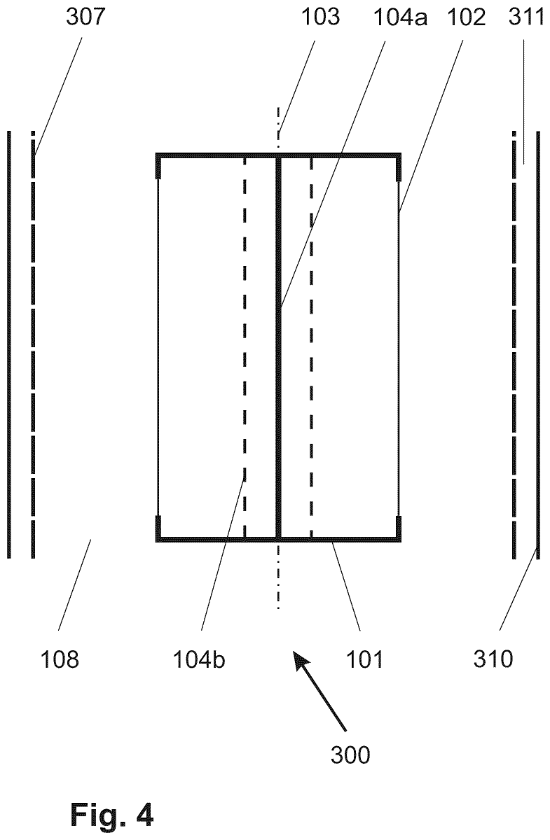

FIGS. 3 and 4 show schematic representations of a first alternative apparatus 300 according to the invention, with FIG. 3 showing a horizontal section and FIG. 4 showing a vertical section. The apparatus 300 initially has all of the features, feature variants, and technical functionalities of the apparatus 100 of FIGS. 1 and 2. Deviating therefrom, the apparatus 300 comprises a first hollow cylinder 307 whose wall is not completely closed but rather has a plurality of openings 309. These openings 309 can be embodied, for example, as pores, holes, or slots.

For the purpose of introducing a working gas into the fluid to be treated, the apparatus 300 comprises a second hollow cylinder 310 which encloses the first hollow cylinder 307 and defines a second annular free space 311 between the first hollow cylinder 307 and the second hollow cylinder 310. The working gas, which passes through the openings 309 of the first hollow cylinder 307 into the first annular free space 108, can then be introduced into the second annular free space 311 under overpressure.

If a fluid to be treated with accelerated electrons is in the form of a liquid, the introduction of a working gas through pore-shaped openings 309 of the hollow cylinder 307 causes the formation of microbubbles within the liquid and to intensive swirling thereof. This, in turn, causes a statistical dose equalization within the liquid volume and causes a decreasing density within the liquid and thus (for a given minimum selectable acceleration voltage) to an increasing range of the accelerated electrons.

A reactive working gas (e.g., oxygen) can be chemically converted under the influence of the accelerated electrons (e.g., oxygen into ozone) and contribute to a further increase in the reactivity or the desired chemical effect of the irradiation process.

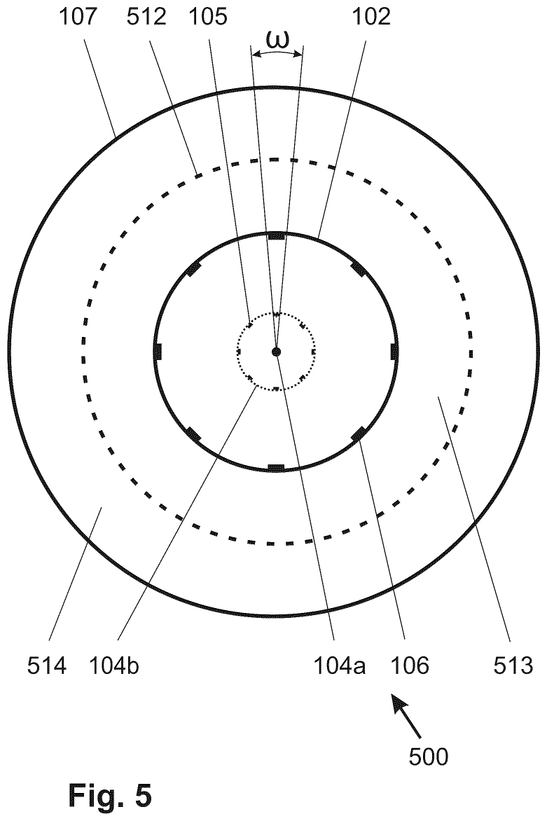

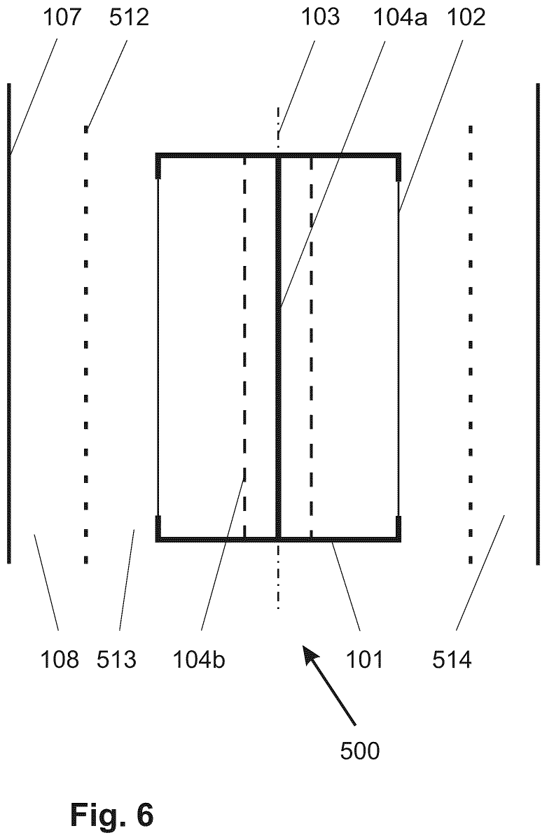

FIGS. 5 and 6 schematically illustrate a second alternative apparatus 500 according to the invention, with FIG. 5 showing a horizontal section and FIG. 6 showing a vertical section. The apparatus 500 initially has all of the features, feature variants, and associated technical functionalities of the apparatus 100 from FIGS. 1 and 2 or, alternatively, all of the features, feature variants, and technical functionalities of the apparatus 300 of FIGS. 3 and 4. In addition, the apparatus 500 comprises a third hollow cylinder 512 whose diameter is larger than the diameter of the cylindrical electron exit window 102 but smaller than the diameter of the first hollow cylinder 107. The cylinder axes of the first hollow cylinder 107, the third hollow cylinder 512, and the electron exit window 102 are identical. The third hollow cylinder 512 thus subdivides the first annular free space 108 into an inner annular free space 513 and an outer annular free space 514. A fluid to be impinged with accelerated electrons is passed through the outer annular free space 514, and a protective gas is passed through the inner annular free space 513. The protective gas, which simultaneously also cools the cylindrical electron exit window 102, ensures that the fluid, which may also contain dirt or other particles, does not make any mechanical contact with the electron exit window, thus improving the useful life of the cylindrical electron exit window 102.

In particular, if a fluid to be treated with accelerated electrons is gaseous and mixing of the gas to be treated with the protective gas is not critical, the third hollow cylinder 512 can be lattice-shaped and, e.g., embodied as a gauze fabric. If, on the other hand, liquids or suspensions are to be treated with accelerated electrons and mixing thereof with the protective gas is to be avoided, it is advantageous if the third hollow cylinder 512 is embodied as a continuously closed but thin film which reliably separates the fluid to be treated and the protective gas but is sufficiently transparent for the passage of accelerated electrons. In alternative embodiments, such a film may also be perforated.

If, however, the treatment of the fluid flowing in the outer annular free space 514 is to be deliberately supported by an (inert or reactive) working gas, the wall of the third hollow cylinder 512 may be provided with pore-, hole-, or slit-shaped openings and an overpressure can be maintained in the inner annular free space 513 with respect to the outer annular free space 514. This prevents the fluid to be treated from entering the electron exit window 102 but, at the same time, allows the protective gas from the inner annular free space 513 to enter the fluid flowing in the outer annular free space 514. If it is a liquid, this occurs in the form of microbubbles, which reduce the density of the liquid (thus increasing the electron range) and swirl it (i.e., promoting the uniformity of the applied dose). If an oxygen-containing working gas is used as the protective gas, ozone is already formed in the inner annular free space 513 (with increased yield compared with the embodiment described in connection with FIGS. 3 and 4) and, for example, the degradation of pollutants in wastewater as intended by the electron treatment is intensified. Alternatively, the first hollow cylinder 107 can be provided with openings in order admix the working gas and press it from the outside into the outer annular free space.

If the electron treatment is intended for plasma-chemical reactions, such as, e.g., the degradation of pollutants in (combustion or industrial) exhaust gases, the splitting of greenhouse gases (e.g., carbon dioxide or methane), or the conversion of multi-component gas mixtures (e.g., for the synthesis of chemical energy storage devices), another embodiment of the invention is advantageous in which the first hollow cylinder 107 is electrically insulated from the third hollow cylinder 512 and the latter is electrically connected to the electron exit window 102. By means of a third power supply unit, an electrical voltage can be generated between the first hollow cylinder 107 and the third hollow cylinder 512 which is suitable for igniting and maintaining a plasma within the outer annular free space 514. It is especially advantageous to select the differential voltage in such a way that a non-independent glow discharge supported by the beam electrons forms in the outer annular free space 514. This is characterized in that it stabilizes as a large-area, uniform volume discharge even in a rough vacuum or even at atmospheric pressure (i.e., preventing transformation thereof into a filament or arc discharge) and the energy of the plasma electrons can be selectively adapted to the excitation of plasma-chemically active intramolecular vibrational states of the reactants. This requires a voltage of 1 kV to 5 kV per 1 cm radial distance between the first hollow cylinder 107 and the third hollow cylinder 512. An especially high-power density and energy efficiency of this plasma are achieved when the energy supply is pulsed by the third power supply unit.

It is known that plasmas do not have a deep-acting effect, but rather at least near-surface chemical and disinfecting effects on media impinged with the plasma. This also enhances the effects of an electron treatment if the first hollow cylinder 107 constitutes part of the inner wall of a hollow body, which must have sufficient electrical conductivity for this purpose.

In principle, it is possible to connect the third hollow cylinder 512 and, therewith, the electron exit window 102, as well, to ground potential and apply the differential voltage supplied by the third power supply unit to the first hollow cylinder 107. However, it appears advantageous to reverse this, i.e., to connect the first hollow cylinder 107 to ground potential and the third hollow cylinder 512 and the electron exit window 102 to the differential voltage potential.

The latter variant makes it possible to conceive of the first hollow cylinder 107 as a continuous wall of a long pipeline (e.g., in a chemical plant or as the exhaust line of a marine engine) into which the electron source (consisting of cathode 104a, control grid 104b, electron exit window 102) is installed in an electrically insulated manner and protected by the third hollow cylinder 512, which acts as a counter electrode of the electron-beam-assisted hybrid plasma. Aerodynamically shaped front-end pieces above and below the cylindrical electron source integrated with the third hollow cylinder 512 ensure a largely non-turbulent flow of the fluid to be treated flowing around the components installed in the center of the surrounding pipeline.

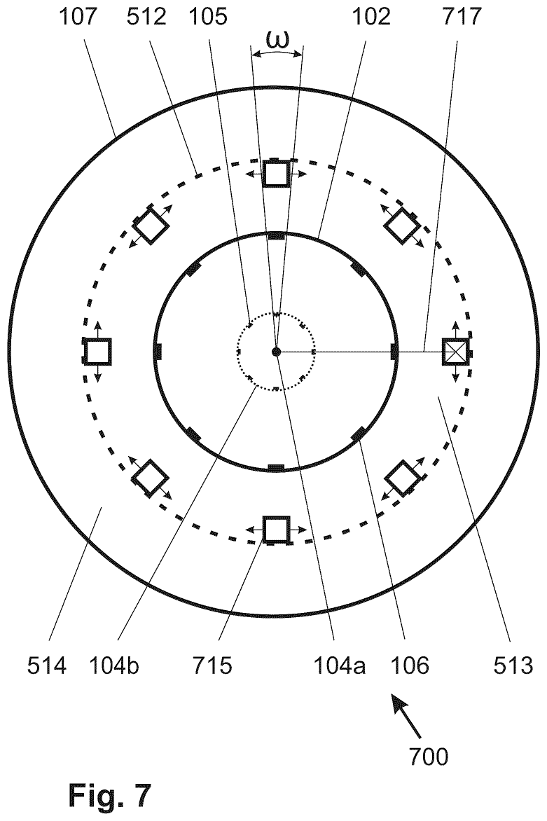

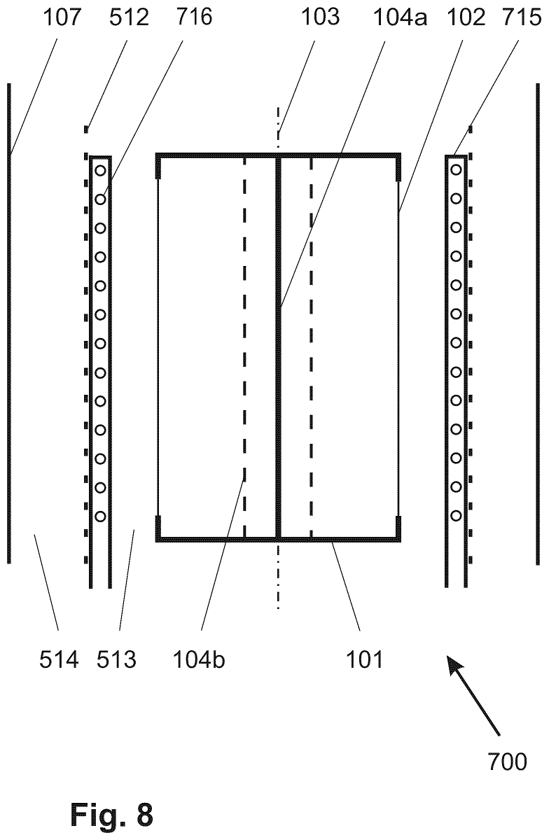

FIGS. 7 and 8 show schematic representations of a third alternative apparatus 700 according to the invention, with FIG. 7 showing a horizontal section and FIG. 8 showing a vertical section of the apparatus 700. The apparatus 700 initially has all of the features, feature variants, and technical functionalities described in relation to the apparatus 500 of FIGS. 5 and 6.

In addition, the apparatus 700 also comprises a number of gas pipes 715 which extend within the inner annular free space 513 parallel to the cylinder axis 103 of the cylindrical housing 101. With their previously described orientation, the gas pipes 715 represent, as a module, the component which makes possible free scalability of the axial length (vertical extension) of the cylindrical electron source and the function-determining components thereof, which is desirable for higher dose rates. In a preferred embodiment, all gas pipes 715 are spaced apart by an identical first dimension from the cylinder axis 103 of the cylindrical housing 101 and by an identical second dimension from a respective adjacent gas pipe 715. In the embodiment described in the example, the gas pipes 715 have a rectangular cross section. Alternatively, however, other geometric shapes for the cross section of the gas pipes 715, such as a circular cross section, can also be realized. Each gas pipe 715 has bores 716 on two oppositely situated wall areas along the longitudinal extension of the gas pipes 715, through which a gas can be introduced into the inner annular free space 513. The bores 716, which are formed in the gas pipes 715 with a preferred diameter of approximately 1 mm or below, extend at least over a gas pipe length range, which is situated opposite the cylindrical electron exit window 102 and thus corresponds to the height of the cylindrical electron exit window 102. The bores 716 are preferably introduced into the gas pipes 715, and the gas pipes 715 are aligned such that the outlet direction of the gas passes through a bore 716 within a horizontal plane of the apparatus 700 and is aligned perpendicularly to a straight line 717 which is drawn from the cylinder axis 103 of the cylindrical housing 101 toward the center of a horizontal sectional surface of an associated pipe 715. The exit direction of the gas through the bores 716 is illustrated in FIG. 7 with arrows on the gas pipes 715. For example, air or an inert gas can be used as the gas. Finally, it should be mentioned that the gas pipes 715 are connected by means of a piping system to a reservoir within which the gas is located. The reservoir can also comprise the ambient air of an apparatus according to the invention.

Instead of the individual bores 716, a vertical slot can alternatively be inserted in the walls of the gas pipes 715 on the oppositely situated wall areas of the gas pipes 715, which slot extends over the height of the electron exit window 102. The vertical slot has a width of approximately 1 mm or less and is dimensioned in any case such that its cross section is smaller than that of the supplying gas pipe, thus achieving equalization of the hydrostatic pressure in the gas pipe and, as a result, of the gas flow out of the slot, as well. (This consideration also applies to the total cross section of the alternative bores relative to that of the gas pipes.)

If a gaseous fluid that is to be treated with accelerated electrons flows through the outer annular free space 514 or is a liquid fluid, which merely runs down the inner wall of the first hollow cylinder 107 as a liquid film, the third hollow cylinder 512 can be designed in the manner of a grid. A gauze material, e.g. consisting of a wire mesh can be used for this purpose. In such an embodiment of the apparatus 700, the gas introduced into the inner annular free space through the bores 716 escapes to the outside through the grid-shaped third hollow cylinder 512 and is discharged in the outer annular free space 514 with the flow of the fluid that is to be impinged with accelerated electrons. The gas flowing through the bores 716 fulfills two tasks. First, the gas penetrating outward through the third hollow cylinder 512 prevents dust particles from passing inward through the third hollow cylinder 512 toward the electron exit window 102, thereby protecting the electron exit window 102 from a parasitic dust-particle coating. The gas is therefore also referred to as protective gas. Second, the flow of the protective gas within the inner annular free space 513 simultaneously cools the cylindrical electron exit window 102. As a result, water cooling of a support grid for the electron exit window 102 may also be dimensioned smaller.

It is advantageous if the gas pipes 715 are in mechanical contact with the third hollow cylinder 512 or if the gas pipes 715 are mechanically connected to the third hollow cylinder 512. This mechanically stabilizes the third hollow cylinder 512 and holds it in place. The gas pipes 715 and the third hollow cylinder 512 are then designed, for example, as a compact module, which can be removed in one piece during maintenance work.

In another embodiment, the diameter of the third hollow cylinder 512 is selected such that its cylindrical wall is arranged centrally between the first hollow cylinder 107 and the cylindrical electron exit window 102.

In another embodiment, the annular width of the inner annular free space 513 is selected such that the gas pipes 715 fill at least 90 percent of the distance between the cylindrical electron exit window 102 and the third hollow cylinder 512.

However, one disadvantage of using the gas pipes 715 in an apparatus according to the invention is that the gas pipes 715 are not sufficiently transparent for accelerated electrons. According to the invention, the gas pipes 715 are therefore likewise arranged in the obscuration angle regions with the angle ω.

If, in another embodiment, liquids, abrasive suspensions, and/or sprayed aerosols are used as the fluid which flow through the outer annular free space, the third hollow cylinder 512 is preferably embodied as a thin film which is sufficiently transparent for the passage of accelerated electrons. By means of such a film, the cylindrical electron exit window 102 is protected from mechanical influences by the fluid.

It was already described in the foregoing that a gas is admitted into the inner annular free space 513 by means of gas pipes 715. In particular, if the third hollow cylinder 512 is embodied as a thin foil, the gas pipes 715 can alternatively perform two different functions. In this case, a gas is admitted into the inner annular free space 513 by means of a first group of gas pipes 715, and the gas is sucked out of the inner annular free space 513 again by means of a second group of gas pipes 715. Preferably, a gas pipe 715 of the first group is always arranged adjacent to a gas pipe 715 of the second group.

It has been repeatedly demonstrated that it is impossible to impinge a fluid with a sufficient dose of accelerated electrons within the obscuration angular regions with the angle ω. Therefore, all previously described embodiments comprise mechanical means, so-called “dead zone shields,” which are used to prevent a fluid to be impinged with accelerated electrons from entering the obscuration angular regions. These mechanical means may comprise apertures which cover the obscuration angular regions on the inlet side, i.e., on the side at which a fluid flows into the first annular free space 108 or into the outer annular free space 514. Furthermore, these mechanical means may also comprise walls which extend parallel to the cylinder axis 103 through the first annular free space 108 or the outer annular free space 514 where they separate the obscuration angular regions from the second angular regions of the treatment zone lying in between in the circumferential direction.

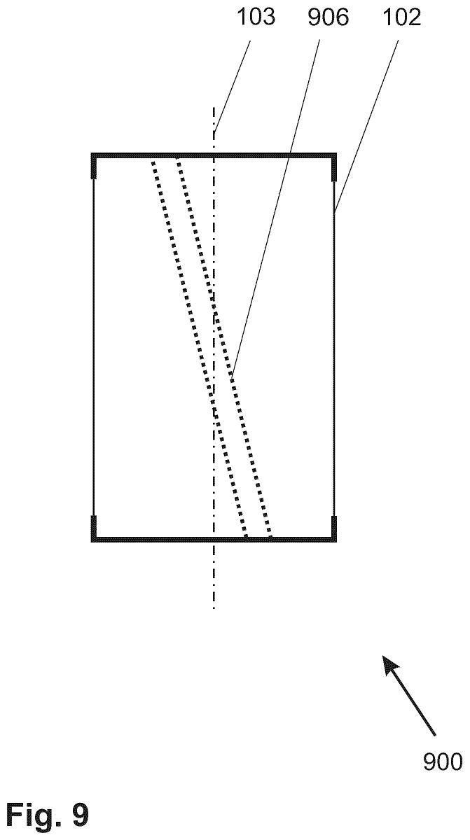

Another embodiment of the invention achieves an equalization of the treatment dose in the flowing fluid without the need for dead zone shields in the treatment chamber. Here, the obscuring structural elements of the previously described apparatuses (i.e., the first support elements 105 of the cylindrical control grid 104b; the second support elements 106 of the electron exit window 102, and, from the apparatus 700 onward, the gas pipes 715) continue to be guided along the respective associated lateral surfaces and point-symmetrically aligned but no longer so as to be parallel to the common central cylinder axis, but rather in the form of a helical curve. Their pitch is selected such that, after passing through the (approximately) vertical opening length of the electron exit window, an azimuthal rotation by an angle Ω is realized.—Where Ω is the angle whose apex lies on the cylinder axis and whose legs pass through the center of two adjacent obscuring structural elements. With regard to the aforementioned lateral surfaces, it should be noted that the control grid 104b is to be regarded as the lateral surface for the first support elements 105; the electron exit window 102 is to be regarded as the lateral surface for the second support elements 106; and the third hollow cylinder 512 is to be regarded as the lateral surface for the gas pipes 715. FIG. 9 shows a schematic of a component 900 of an apparatus according to the invention which comprises an electron exit window 102. Only by way of example, a single second support element 906 is shown in FIG. 9, which is intended to illustrate the orientation of electron-obscuring structural elements such as first support elements and second support elements, as well as of gas pipes 715 in such an embodiment. The second support element 906, which is represented by dotted lines, extends in a helical curve along its associated lateral surface, the electron exit window 102, from top to bottom, the slope of the helical curve being very steep. It should be noted that, even in such an embodiment, the electron-obscuring structural elements, such as first and second support elements and, optionally, gas pipes 715, are all arranged within the first angle elements with the angle ω, but the angle ω rotates along the cylinder axis 103 with the helical curve of the electron-obscuring structural elements around the cylinder axis 103.

To clarify the use of and to hereby provide notice to the public, the phrases “at least one of <A>, <B>, . . . and <N>” or “at least one of <A>, <B>, . . . or <N>” or “at least one of <A>, <B>, . . . <N>, or combinations thereof” or “<A>, <B>, . . . and/or <N>” are defined by the Applicant in the broadest sense, superseding any other implied definitions hereinbefore or hereinafter unless expressly asserted by the Applicant to the contrary, to mean one or more elements selected from the group comprising A, B, . . . and N. In other words, the phrases mean any combination of one or more of the elements A, B, . . . or N including any one element alone or the one element in combination with one or more of the other elements which may also include, in combination, additional elements not listed. Unless otherwise indicated or the context suggests otherwise, as used herein, “a” or “an” means “at least one” or “one or more.”

1. An apparatus for impinging fluids and inner walls of hollow bodies with accelerated electrons, comprising: a cylindrical electron exit window as a component of a cylindrical housing having a cylinder axis and enclosing an evacuable space; at least one wire-shaped, strand-shaped, rod-shaped, annular, helical, or cylindrical cathode which is arranged within the evacuable space and is enclosed by the cylindrical electron exit window and by a cylindrical control grid, wherein the cylindrical control grid has a diameter that is smaller than the diameter of the cylindrical electron exit window and wherein a first power supply unit is connected in an electrically conductive manner between the wire-shaped, strand-shaped, rod-shaped, annular, helical, or cylindrical cathode and the cylindrical electron exit window, so that electrons are emittable from the wire-shaped, strand-shaped, rod-shaped, annular, helical, or cylindrical cathode and accelerated radially away from the cylinder axis of the cylindrical housing in the direction of the cylindrical electron exit window, wherein
a) a first hollow cylinder encloses the cylindrical electron exit window, and the first hollow cylinder and the electron exit window are spaced apart from one another, so that a first annular free space is formed between the first hollow cylinder and the electron exit window;
b) first support elements of the cylindrical control grid and second support elements of the concentrically arranged, cylindrical electron exit window run so as to be aligned point-symmetrically along the respective lateral surfaces and are arranged azimuthally within equal angular segments with an angle ω.

2. The apparatus of claim 1, wherein the cathode is rod-shaped or cylindrical and embodied as a plasma cathode.

3. The apparatus of claim 1, wherein the wire-shaped, strand-shaped, rod-shaped, annular, helical, or cylindrical cathode is embodied as a hot cathode.

4. The apparatus of claim 3, wherein the wire-shaped, strand-shaped, rod-shaped, annular, helical, or cylindrical cathode is embodied as a hot cathode heated directly by means of current flow.

5. The apparatus of claim 3, wherein the cathode is cylindrical and has a wire-, strand- or rod-shaped heating element extending along the cylinder axis, wherein the cylindrical cathode can be heated by means of thermal conduction, thermal radiation, or electron impact.

6. The apparatus of claim 5, wherein one end of the cylindrical cathode is connected in an electrically conductive manner to one end of the wire-, strand- or rod-shaped heating element.

7. The apparatus of claim 4, wherein the hot cathode comprises a ceramic rod, around which a wire is helically wound.

8. The apparatus of claim 1, wherein the cylindrical control grid has a differential voltage of approximately +20 V to approximately +2000 V with respect to the wire-shaped, strand-shaped, rod-shaped, annular, helical, or cylindrical cathode, wherein a second power supply unit generates the electrical voltage potential for the cylindrical control grid.

9. The apparatus of claim 1, wherein the wire-shaped, strand-shaped, rod-shaped, annular, helical, or cylindrical cathode is securely clamped at only one end and is contacted at the other end with an axially movable clamping piece.

10. The apparatus of claim 1, wherein the radial position of the wire-shaped, strand-shaped, rod-shaped, annular, helical, or cylindrical cathode is adjustable.

11. The apparatus claim 1, wherein a second hollow cylinder encloses the first hollow cylinder, so that a second annular free space is formed between the first hollow cylinder and the second hollow cylinder.

12. The apparatus of claim 11, wherein the wall of the first hollow cylinder is completely closed or has openings.

13. The apparatus of claim 1, wherein a third hollow cylinder is arranged between the cylindrical electron exit window and the first hollow cylinder, which third hollow cylinder divides the first annular free space into an inner annular free space and an outer free space, wherein the third hollow cylinder is embodied in the form of a grid or as a continuously closed or perforated film.

14. The apparatus of claim 13, wherein a number of gas pipes extend within the inner annular free space parallel to the cylinder axis of the cylindrical housing and within the angular segments with the angle ω, wherein all gas pipes are spaced apart by an identical first dimension from the cylinder axis of the cylindrical housing and by an identical second dimension from an adjacent gas pipe, and wherein each gas pipe has bores on oppositely situated wall regions or at least one slot along the longitudinal extent of the gas pipe through which a gas can be introduced into the inner annular free space.

15. The apparatus of claim 14, wherein the gas pipes are attached to the third hollow cylinder.

16. The apparatus of claim 14, wherein the first hollow cylinder is designed to be electrically insulated from the third hollow cylinder, and a third power supply unit generates an electrical differential voltage between the first hollow cylinder and the third hollow cylinder in order to ignite and maintain a plasma supported by the electron beam within the outer annular free space.

17. The apparatus of claim 1, wherein the cylinder axis of the cylindrical housing is oriented perpendicular to the Earth's surface or deviates from the vertical by an angle of approximately 100 or less.

18. The apparatus of claim 1, wherein the first annular free space or the outer annular free space is covered on the inlet side in the angular regions with the angle ω by means of mechanical diaphragms, and that walls extend parallel to the cylinder axis through the first annular free space or through the outer annular free space, which walls separate the angular regions with the angle ω from the angular regions lying in between.

19. The apparatus of claim 1, wherein the first support elements of the cylindrical control grid and the second support elements of the cylindrical electron exit window are embodied so as to be parallel to the cylinder axis.

20. The apparatus of claim 1, wherein the first support elements of the cylindrical control grid and the second support elements of the electron exit window run so as to be aligned point-symmetrically along the respective lateral surface in the form of a helical curve.
